(19) United States
(12) Patent Application Publication
(10) Pub. No.: US 2015/0339069 A1
(43) Pub. Date: Nov. 26, 2015

(54) MEMORY SYSTEM AND METHOD

(71) Applicant: Kabushiki Kaisha Toshiba, Minato-ku (JP)

(72) Inventors: Ryuji Nishikubo, Kawasaki (JP); Hiroki Matsudaira, Funabashi (JP); Norio Aoyama, Machida (JP)

(73) Assignee: Kabushiki Kaisha Toshiba, Minato-ku (JP)

(21) Appl. No.: 14/479,642

(22) Filed: Sep. 8, 2014

Related U.S. Application Data
(60) Provisional application No. 62/001,983, filed on May 22, 2014.

(51) Int. Cl. G06F 3/06

(52) U.S. Cl. CPC G06F 3/0619; G06F 3/0688; G06F 3/0655; G06F 2206/1014

(57) ABSTRACT

According to one embodiment, a memory system includes a first memory, a second memory, and a processor. The second memory stores first management information and second management information. The first management information has an information that associates a logical address with a physical address. The second management information has an information which has a volume of valid data in each block included in the first memory. The controller updates the first management information and the second management information. When saving a differential data in the first memory, the controller stores the differential data and the second management information in one page of the first memory. The differential data is a difference between before and after update of the first management information. When restoring the second management information, the controller loads to the second memory the second management information stored in the first memory.

### CROSS-REFERENCE TO RELATED APPLICATIONS

This application is based upon and claims the benefit of priority from U.S. Provisional Application No. 62/001,983, filed on May 22, 2014; the entire contents of which are incorporated herein by reference.

### FIELD

Embodiments described herein relate generally to a memory system and a method.

### BACKGROUND

A volume of valid data in each block is managed in a memory system such as an SSD (Solid State Drive). The volume of valid data is recorded in a volatile memory included in the memory system. A recorded value of the volume of valid data is successively updated on the volatile memory and is referenced when determining a block that is to be subjected to compaction, for example.

### BRIEF DESCRIPTION OF THE DRAWINGS

FIG. 1 is a diagram illustrating an example of a configuration of a memory system according to first embodiment;

FIG. 2 is a diagram illustrating various data stored in the memory system;

FIG. 3 is a diagram illustrating an example of a process pertaining to the handling of translation information;

FIG. 4 is a diagram illustrating an example of a data structure of cluster information;

FIG. 5 is a diagram illustrating an example of data organization of a differential record according to the first embodiment;

FIG. 6 is a flowchart illustrating second save processing according to the first embodiment;

FIG. 7 is a flowchart illustrating an operation of restoring the cluster information;

FIG. 8 is a diagram illustrating an example of data organization of a differential record according to second embodiment; and

FIG. 9 is a flowchart illustrating second save processing according to the second embodiment.

### DETAILED DESCRIPTION

In general, according to one embodiment, a memory system includes a first memory, a second memory, and a controller. The first memory includes a plurality of blocks. Each of the plurality of blocks includes a plurality of pages. Each of the plurality of pages is a unit of data writing. The second memory stores first management information and second management information. The first management information associates a logical address specified from outside with a physical address of the first memory. The second management information includes an information which has a volume of valid data in each block. The controller updates the first management information and the second management information in accordance with data written into the first memory. The controller stores a differential data and the second management information in one page of the first memory when saving the differential data in the first memory. The differential data is a difference between before and after update of the first management information. The controller loads to the second memory the second management information stored in the first memory when restoring the second management information.

Exemplary embodiments of the memory system and the method will be explained below in detail with reference to the accompanying drawings. The present invention is not limited to the following embodiments.

### First Embodiment

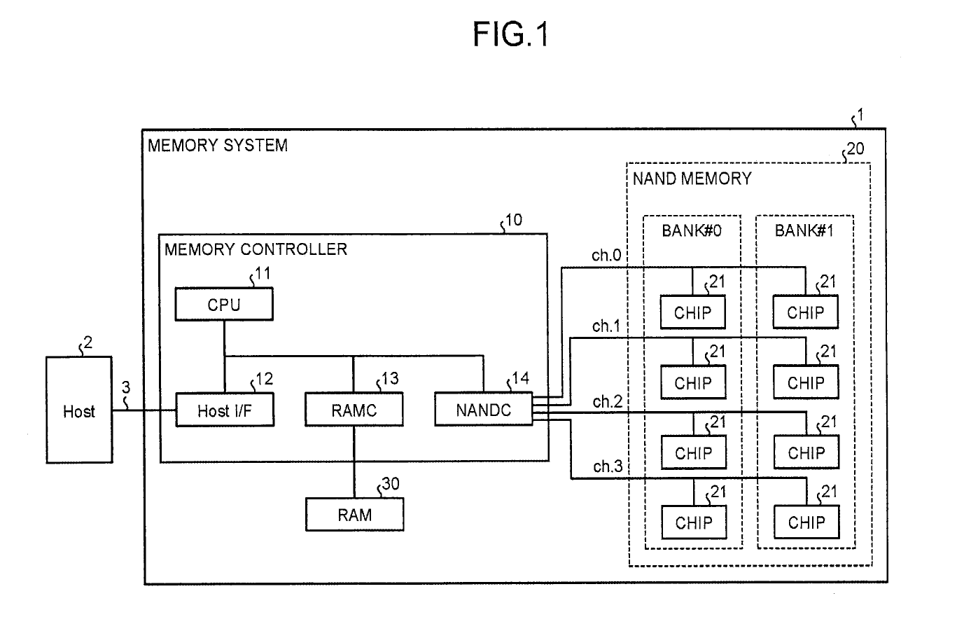

FIG. 1 is a diagram illustrating an example of a configuration of a memory system according to first embodiment. A memory system 1 is connected to a host 2 through a communication channel 3. The host 2 is a computer. The computer in this case includes a personal computer, a portable computer, or a mobile communication device, for example. The memory system 1 functions as an external storage device of the host 2. An arbitrary standard can be adopted as an interface standard of the communication channel 3. The host 2 can issue a write command and a read command to the memory system 1. Each of the write command and the read command includes logical address information specifying an access destination.

The memory system 1 includes a memory controller 10, a NAND-type flash memory (NAND memory) 20 used as a storage, and a RAM (Random Access Memory) 30. Note that the type of memory used as the storage is not limited to the NAND-type flash memory. That is, a NOR-type flash memory, a ReRAM (Resistance Random Access Memory), or an MRAM (Magnetoresistive Random Access Memory) can be adopted as the storage, for example.

The NAND memory 20 includes one or more memory chips (CHIP) 21. Here, the NAND memory 20 includes eight of the memory chips 21. The memory chip 21 includes a plurality of memory cell arrays. Each memory cell array includes a plurality of memory cells arrayed into a matrix. Each memory cell array includes an array of a plurality of physical blocks, each of which is the unit by which erase processing is performed on the memory cell array. Each physical block includes a plurality of pages, each of which is the unit by which read processing and write processing are performed on the memory cell array. The size of each page is several times as large as a cluster which is smaller than the page. That is, each page stores page-sized data including a plurality of cluster data.

In each memory chip 21, erase processing is performed by the unit of the physical block. Accordingly, in writing second data by specifying a logical address identical to that of first data from the host 2 while the first data is stored in the NAND memory 20, the second data is written in a blank page instead of erasing the first data. The first data is treated as invalid data after the second data is written. The write processing is performed on the NAND memory 20 in such method, whereby the invalid data and valid data are mixed in the data stored in each physical block.

Each of the eight memory chips 21 configuring the NAND memory 20 is connected to the memory controller 10 through any of four channels (ch.0 to ch.3). Here, two of the memory chips 21 are connected to each channel. Each memory chip 21 is connected to only one of the four channels. Each channel includes a wiring group including an I/O signal line and a control signal line. The I/O signal line is a signal line adapted to transmit/receive data, an address, and a command, for example. The control signal line is a signal line adapted to transmit/receive a WE (write enable) signal, an RE (read enable) signal, a CLE (command latch enable) signal, an ALE (address latch enable) signal, and a WP (write protect) signal, for example. The memory controller 10 can control each channel individually. The memory controller 10 controls the four channels in parallel and individually to be able to operate the four memory chips 21 connected to the different channels in parallel.

Moreover, the eight memory chips 21 include a plurality of banks capable of bank interleaving. The bank interleaving is a method of parallel operation. Specifically, the bank interleaving is the method of reducing a total transfer time between the NAND memory 20 and the memory controller 10 by causing the memory controller 10 to issue an access request to a bank while one or more of the memory chips 21 belonging to another bank are accessing the data. The two banks are distinguished as a BANK #0 and a BANK #1 in this case. More specifically, one of the two memory chips 21 connected to each channel configures the BANK #0, while another one of the two memory chips 21 configures the BANK #1.

Moreover, the memory cell array included in each memory chip 21 may be divided into a plurality of regions (Districts) which can be operated independently from one another. Each District includes a plurality of physical blocks. Each District includes peripheral circuits (such as a row decoder, a column decoder, a page buffer, and a data cache) independent from one another so that the processing (erase, write, and read) can be executed to the plurality of Districts in parallel.

As a result, the memory controller 10 can operate the total of eight memory chips 21 in parallel by operating the four channels in parallel and causing the two banks to interleave. Furthermore, the memory controller 10 accesses the Districts in each memory chip 21 in parallel. That is, in a case where each memory chip 21 includes two Districts, for example, the memory controller 10 can access 16 physical blocks in parallel.

The memory controller 10 lumps together the plurality of physical blocks the controller can access in parallel, and manages the blocks as one logical block. The plurality of physical blocks configuring the logical block is erased in a lump, for example. The memory controller 10 further executes compaction (also referred to as garbage collection) for each logical block. The compaction will be described later.

The RAM 30 stores management information (management information 31) that is used by the memory controller 10 to access the NAND memory 20. The management information 31 will be described in detail later on. Moreover, the RAM 30 is used by the memory controller 10 as a buffer to transfer data between the host 2 and the NAND memory 20.

The memory controller 10 includes a CPU (Central Processing Unit) 11, a host interface (Host I/F) 12, a RAM controller (RAMC) 13, and a NAND controller (NANDC) 14. The CPU 11, the Host I/F 12, the RAMC 13, and the NANDC 14 are connected to one another by a bus.

The Host I/F 12 executes control on the communication channel 3. The Host I/F 12 also receives a command from the host 2. Moreover, the Host I/F 12 executes data transfer between the host 2 and the RAM 30. The RAMC 13 controls the RAM 30. The NANDC 14 executes data transfer between the RAM 30 and the NAND memory 20. The CPU 11 functions as a processor which executes overall control on the memory controller 10 on the basis of a firmware program.

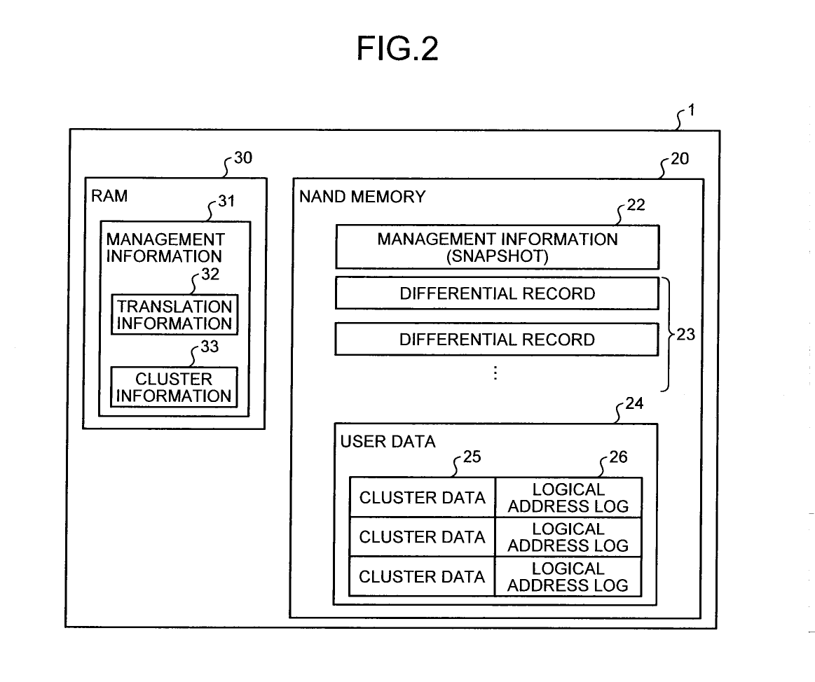

FIG. 2 is a diagram illustrating various data stored in the memory system 1.

The NAND memory 20 stores data (user data 24) for which a write request is made by a write command. When writing the user data 24, the processor associates a logical address log 26 with a cluster-sized data (cluster data 25) configuring the user data 24 and stores the logical address log 26. The logical address log 26 is a piece of information indicating a logical address specified for the cluster data 25 when writing the cluster data 25. An operation of translating the logical address into the physical address is referred to as lookup. Moreover, an operation of using the logical address log 26 to translate the physical address into the logical address is referred to as reverse lookup.

Note that the logical address log 26 may be stored at a location having an address continuous with an address of the location where the corresponding cluster data 25 is written, or need not be stored at the location having the address continuous with the address of the location where the corresponding cluster data 25 is written. Moreover, the logical address log 26 may be stored in the same logical block as the corresponding cluster data 25 or in a logical block different therefrom.

The RAM 30 stores the management information 31 used to manage the NAND memory 20. The management information 31 includes translation information 32 and cluster information 33.

The translation information 32 to be used in the lookup is a piece of information in which the correspondence between the logical address and the physical address is recorded. The translation information 32 is updated every time write processing is performed on the NAND memory 20. When a power supply is discontinued, the translation information 32 needs to be restored to a state immediately before the power supply is discontinued. In order for the translation information 32 to be restored at any time, the processor performs processing (hereinafter referred to as first save processing) of copying the translation information 32 on the RAM 30 as is into the NAND memory 20, and processing (second save processing) of recording into the NAND memory 20 a change in the translation information 32 as a differential log (differential log 27 to be described later). Here, it is assumed that the management information 31 is copied to the NAND memory 20 by the first save processing, and the management information 31 copied to the NAND memory 20 is called a snapshot (snapshot 22).

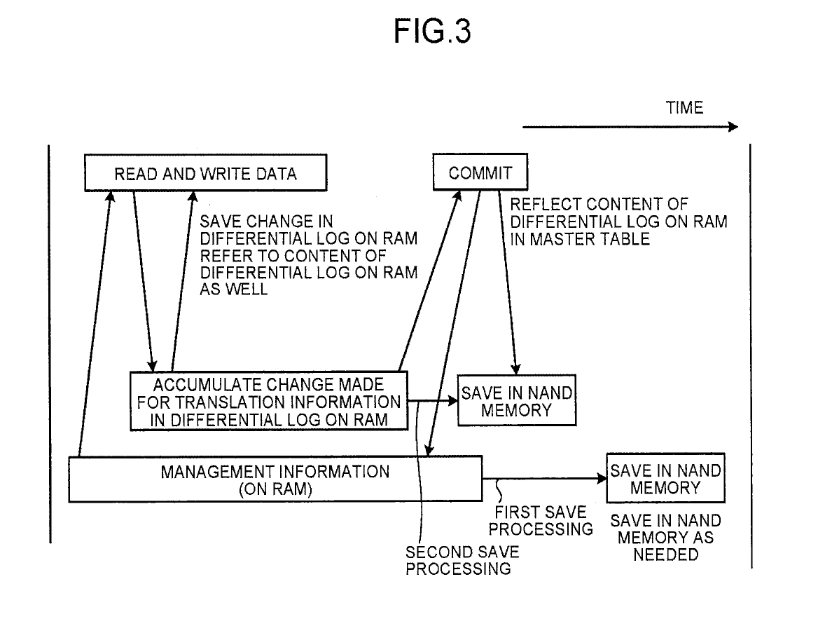

FIG. 3 is a diagram illustrating an example of the process pertaining to the handling of the translation information 32. When updating the translation information 32, the processor accumulates on the RAM 30 the differential log 27 indicating the change caused by the update. The processor may directly update the translation information 32 itself and at the same time accumulate the change on the RAM 30, or accumulate the differential log 27 on the RAM 30 without updating the translation information 32 itself. When not updating the translation information 32 itself, the processor refers to the differential log 27 on the RAM 30 in addition to the translation information 32 at the time of the lookup.

Once the data update becomes stable, the processor executes commit processing of the log. The commit processing is a processing of reflecting the content of the differential log 27 in the translation information 32 as needed and executing the first save processing or the second save processing. The first save processing is executed at the time of a normal power interruption sequence and at the time of shortage of an area in which the differential log 27 is saved, for example.

The processor thus executes the second save processing after the first save processing is executed until the next first save processing is executed. Therefore, the processor can restore the most up-to-date translation information 32 by using the snapshot 22 recorded by the first save processing and the differential log 27 recorded by the second save processing.

The cluster information 33 is a piece of information in which the volume of valid data in each region of a predetermined unit size is recorded.

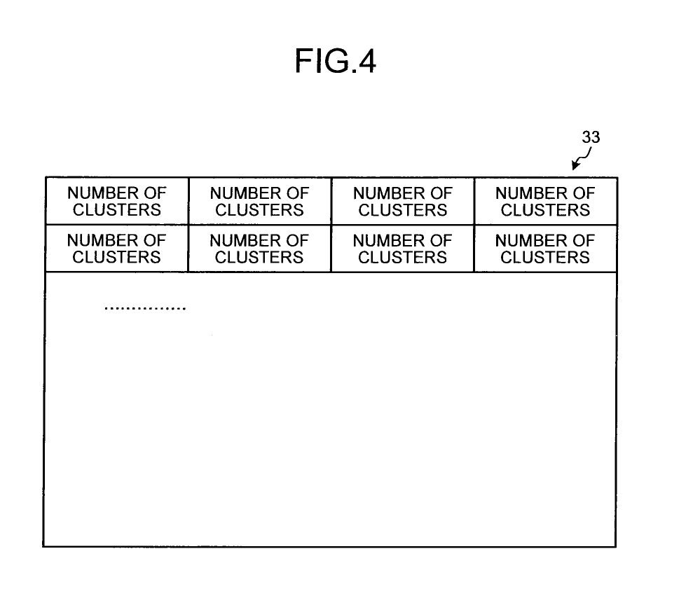

FIG. 4 is a diagram illustrating an example of a data structure of the cluster information 33. Here, as an example, the number of valid cluster data 25 (the number of clusters) for each logical block is recorded in the cluster information 33. The number of valid cluster data 25 for each physical block may instead be recorded in the cluster information 33. The cluster information 33 is configured such that the number of valid cluster data 25 is recorded in order from the top. Each region in which the number of valid cluster data 25 is recorded is fixed in size, for example. The location of each region is associated one-to-one with any one of the logical blocks configuring the NAND memory 20. The processor updates the cluster information 33 every time the write processing is performed on the NAND memory 20.

The cluster information 33 is referenced by the processor at the time of the compaction, for example. The compaction refers to the processing of creating a free block. The memory controller 10 collects valid data written in one or more of the logical blocks and moves the collected valid data to another logical block, for example. The memory controller 10 thereafter executes the erase processing on the logical block from which the data is moved. The processor refers to the cluster information 33 to select, as a target of the compaction (or the logical block from which the data is moved), the logical block having the smallest volume of valid data, for example.

A valid cluster determination process is performed to be able to strictly determine whether each cluster data 25 is valid or invalid. In the valid cluster determination process, the processor performs the reverse lookup and the lookup on each cluster data 25. The processor determines that the cluster data 25 is valid when a physical address used in the reverse lookup and a physical address retrieved by the lookup are the same. The processor determines that the cluster data 25 is invalid when the two physical addresses are different. The processor performs the valid cluster determination process on each cluster data 25 stored in the logical block on which the compaction is to be executed.

The cluster information 33 being stored on the RAM 30, there occurs an error between a value recorded in the restored cluster information 33 and an actual value when the information is restored from the snapshot 22 after invalid power interruption. The error can be corrected by the valid cluster determination process. The valid cluster determination process to correct the error may be performed at the time of the compaction as well as at an arbitrary timing. However, the valid cluster determination process requires a high computational cost, thereby causing a delay in responding to the host 2 when the valid cluster determination process is performed frequently. Moreover, the snapshot 22 recorded by the first save processing has a relatively large size. The increase in error can be reduced by frequently executing the first save processing, which however increases the number of write and erase processings performed on the NAND memory 20 and exhausts the NAND memory 20. As a result, it is desired to keep the error from getting large as much as possible without performing the first save processing frequently and by keeping down the frequency of the valid cluster determination process performed to correct the error. Accordingly, in the first embodiment, the processor records the cluster information 33 along with the differential log 27 in the NAND memory 20 in the second save processing.

Each differential record 23 is a piece of data written in the NAND memory 20 in a single run of the second save processing. One new differential record 23 is written in the NAND memory 20 every time the second save processing is performed.

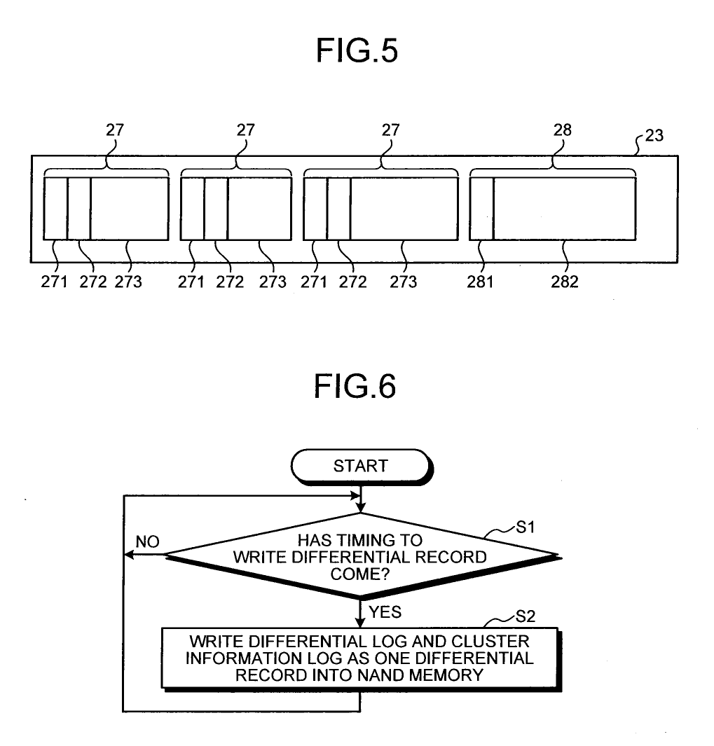

FIG. 5 is a diagram illustrating an example of the data organization of the differential record 23 according to the first embodiment. As described above, the write processing is performed on each memory chip 21 by the unit of a physical page. The differential record 23 has a size equivalent to a single page. That is, the second save processing is performed before the differential log 27 worth a single page is accumulated in the RAM 30. The differential record 23 includes one or more of the differential logs 27 and one cluster information log 28. Each differential log 27 includes an ID 271, size information 272, and a body 273. The ID 271 is a piece of identification information indicating that it is the differential log 27 and identifying each differential log 27. The body 273 indicates the content of change in the translation information 32. The size information 272 indicates the size of the body 273. The cluster information log 28 includes an ID 281 that is a piece of identification information indicating that it is the cluster information log 28, and a body 282 that is a copy of the cluster information 33. The invalid data is recorded in the remaining portion of the differential record 23, for example.

Next, the operation of the processor will be described.

FIG. 6 is a flowchart illustrating the second save processing according to the first embodiment. First, the processor determines whether timing to write the differential record 23 (or timing to perform the second save processing) has come (S1). The timing to write the differential record 23 can be set arbitrarily by design. The timing to write the differential record 23 may correspond to timing at which the differential log 27 accumulated on the RAM 30 has a predetermined size smaller than a size obtained by subtracting the size of the cluster information log 28 from the size of the single page, for example. Alternatively, the timing to write the differential record 23 may correspond to timing at which a predetermined number of the differential logs 27 is accumulated on the RAM 30. When the timing to write the differential record 23 has not come yet (S1; No), the processor performs the process in S1 once again. When the timing to write the differential record 23 has come (S1; Yes), the processor records in the NAND memory 20 one or more of the differential logs 27 and the cluster information log 28 as a single differential record 23 (S2), and performs the process in S1 once again.

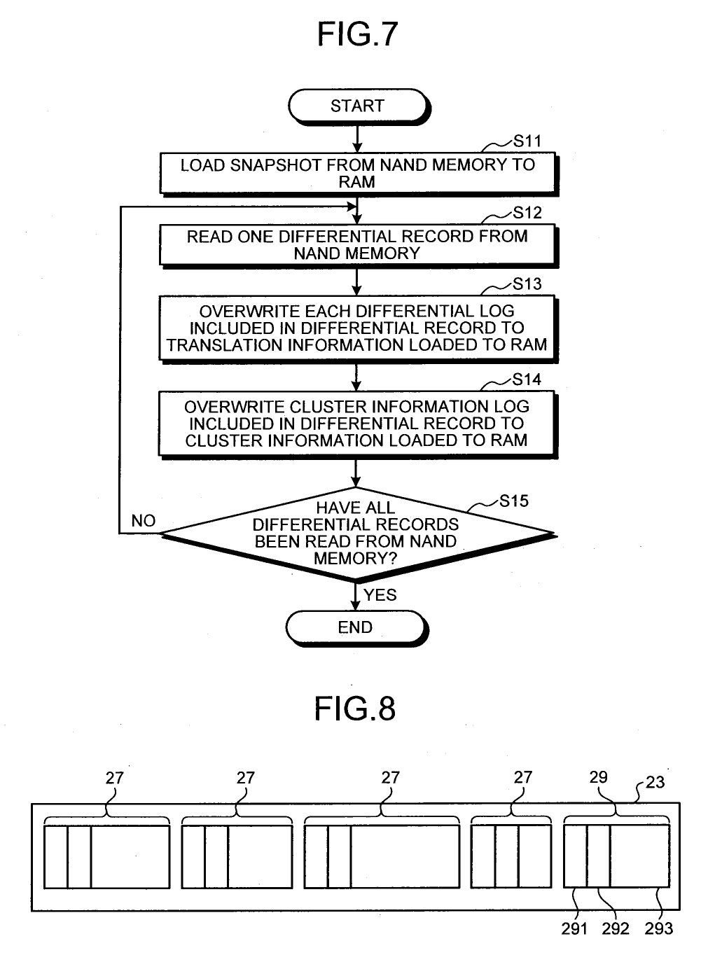

FIG. 7 is a flowchart illustrating the operation of restoring the cluster information 33. First, the processor loads from the NAND memory 20 to the RAM 30 the translation information 32 recorded in the NAND memory 20 as the snapshot 22 (S11). The processor then reads one differential record 23 recorded in the NAND memory 20 from the NAND memory 20 (S12). In S12, the processor reads the oldest differential record 23 on which the process in S13 and on has not yet been performed.

Subsequently, the processor overwrites each differential log 27, which is included in the differential record 23 being read from the NAND memory 20, to the translation information 32 loaded to the RAM 30 (S13). The processor also overwrites the cluster information log 28 (the body 282 to be exact), which is included in the differential record 23 being read from the NAND memory 20, to the cluster information 33 loaded to the RAM 30 (S14). The processor then determines whether or not all the differential records 23 have been read (S15). The processor re-executes the process in S12 when there exists the differential record 23 that has not been read (S15; No). The processor ends the operation when all the differential records 23 have been read (S15; Yes).

Note that in the first embodiment, the processor may be configured to overwrite only the body 282 of the cluster information log 28, which is included in the differential record 23 being recorded last, to the cluster information 33 loaded to the RAM 30. Moreover, the snapshot 22 may be configured to not include the cluster information 33, and the processor may be configured to restore the cluster information 33 by using only the body 282 of the cluster information log 28 included in the all differential records 23 or the last differential record 23.

The data (first management information) recording all as the snapshot 22 and the content of change as the differential log 27 is not limited to the translation information 32. Moreover, the data (second management information) recorded in the differential record 23 along with the differential log 27 is not limited to the cluster information 33. The second management information may include a count value of the number of reads performed in each logical block (or physical block), for example. In order to prevent the data from getting lost by read disturb, the processor refreshes a block when the data written in the block is read for a predetermined number of times. A recorded value of the count value of the number of reads is referenced by the processor as a parameter to specify the block to be refreshed.

In the first embodiment as described above, the processor records the differential log 27 and the cluster information 33 as the differential record 23 in one page of the NAND memory 20 when saving the differential log 27 of the translation information 32 in the NAND memory 20. When restoring the cluster information 33, the processor loads to the RAM 30 the cluster information 33 recorded in the differential record 23. The cluster information 33 can be saved to the NAND memory 20 more frequently than the first save processing, whereby the increase in error in the cluster information 33 can be controlled even when the invalid power interruption occurs repeatedly.

Furthermore, the processor refers to the cluster information 33 to select the logical block on which the compaction is performed. As a result, the processor can select the logical block on which the compaction is performed faster than by performing the valid cluster determination process.

### Second Embodiment

In the second embodiment, a differential record 23 having the size equivalent to one page includes one or more differential logs 27 and a cluster information log (cluster information log 29) which includes a part of cluster information 33. The cluster information log 29 and another data (a differential log 27) added together have the size equivalent to one page. That is, in the second embodiment, a processor records one or more of the differential logs 27 subjected to second save processing in the differential record 23, and records a part of the cluster information 33 having the largest size possible in the remaining space of the differential record 23.

The part of the cluster information 33 to be recorded in the differential record 23 is determined arbitrarily. The processor may preferentially record a part of the cluster information 33 having many changes, for example. Here, the processor records a part following the part that is already recorded by the previous second save processing, for example.

FIG. 8 is a diagram illustrating an example of the data organization of the differential record 23 according to the second embodiment. The differential record 23 includes one or more of the differential logs 27 and one cluster information log 29. The configuration of each differential log 27 is the same as that in the first embodiment. The cluster information log 29 includes an ID 291, offset information 292, and a body 293. The ID 291 is a piece of identification information indicating that it is the cluster information log 29. The body 293 is a copy of a part of the cluster information 33. The offset information 292 is a piece of information indicating from which part of the cluster information 33 the body 293 is copied and indicating a relative location of the body from the top of the cluster information 33. The total size of one or more of the differential logs 27 and the cluster information log 29 equals one page.

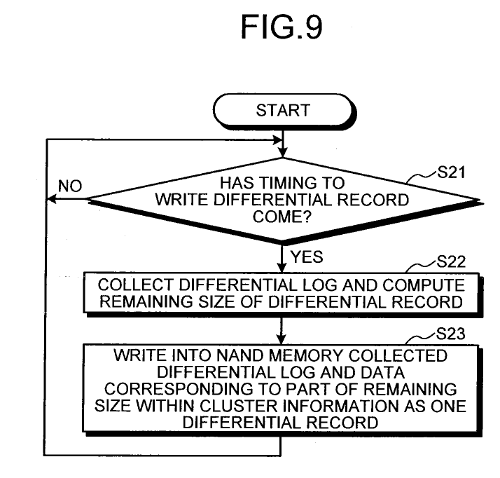

FIG. 9 is a flowchart illustrating the second save processing according to the second embodiment. First, the processor determines whether timing to write the differential record 23 has come (S21). The process performed in S21 is the same as the process performed in S1. When the timing to write the differential record 23 has not come yet (S21; No), the processor performs the process in S21 once again.

When the timing to write the differential record 23 has come (S21; Yes), the processor collects one or more of the differential logs 27 to be recorded and computes the remaining size of the differential record 23 (S22). To be more exact, the processor subtracts from the size equivalent to one page the total size of the one or more of the differential logs 27 collected, the size of the ID 291, and the size of the offset information 292, and determines the resultant value as the remaining size. The processor then writes into a NAND memory 20 the differential logs 27 collected as well as data corresponding to a part of the remaining size within the cluster information 33 as a single differential record 23 (S23).

Specifically, the processor computes the value of the offset information 292 by combining the value of the offset information 292 recorded in the cluster information log 29 that is previously generated and the size of the body 293 recorded in the cluster information log 29 that is previously generated. The processor thereafter records the data corresponding to the remaining size in the body 293 from the location indicated by the computed value of the offset information 292 within the cluster information 33. The processor configures the differential record 23 by the cluster information log 29 generated as described above and the differential log 27 collected, and then writes the differential record 23 into the NAND memory 20.

The processor re-executes the process in S21 after executing the process in S23.

In the second embodiment as described above, the processor generates the page-sized differential record 23 by collecting the one or more of the differential logs 27 and the part of the cluster information 33, and records the generated differential record 23 in the NAND memory 20. As a result, the cluster information 33 can be frequently saved in the NAND memory 20 even when the cluster information 33 is large in size, whereby the increase in error in the cluster information 33 can be controlled even when invalid power interruption occurs repeatedly.

The differential record 23 includes the offset information 292 serving as the location information indicating the location of the part of the cluster information 33 to be recorded. The processor can thus recognize at the time of restoring which part of the cluster information 33 is recorded in the differential record 23. In other words, the processor can specify in which part of the cluster information 33 the body 293 read from the differential record 23 is to be overwritten at the time of restoring.

Furthermore, the processor records the part of the cluster information 33 following the part recorded in the previous second save processing, in the next second save processing. This allows the whole cluster information 33 to be saved in the NAND memory 20 by performing the second save processing for a plurality of times even when the cluster information 33 is large in size.

Furthermore, the processor records the whole cluster information 33 in the NAND memory 20 in the first save processing and, at the time of restoring, loads the cluster information 33 recorded by the first save processing to the RAM 30 and then overwrites the body 293 included in the differential record 23 to the cluster information 33 that is loaded to the RAM 30. This allows the whole cluster information 33 to be restored at any timing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a first memory including a plurality of blocks, each of the plurality of blocks including a plurality of pages, each of the plurality of pages being a unit of data writing;
a second memory which stores first management information and second management information, the first management information including an information that associates a logical address specified from outside with a physical address of the first memory, the second management information including an information which has a volume of valid data in each block; and
a controller configured to
update the first management information and the second management information in accordance with data written into the first memory,
store a differential data and the second management information in one page of the first memory when saving the differential data in the first memory, the differential data being a difference between before and after update of the first management information, and
load the second management information stored in the first memory into the second memory when restoring the second management information.

2. The memory system according to claim 1, wherein the controller collects the differential data and first data that is a part of the second management information, and records second data in the first memory, the second data having a size equivalent to one page, the second data including the differential data and the first data.

3. The memory system according to claim 2, wherein the second data includes location information indicating a location at which the first data is stored in the second management information, the second management information being stored in the second memory.

4. The memory system according to claim 3 wherein, when saving the differential data in the first memory, the controller acquires as the first data a third data which follows data corresponding to a part of the second management information stored in the first memory previously, the third data being a part of the second management information.

5. The memory system according to claim 2, wherein the controller records the second management information in the first memory less frequently than the frequency of saving the differential data in the first memory and, when restoring the second management information, loads the second management information recorded in the first memory into the second memory and then overwrites the first data included in the second data to the loaded second management information.

6. The memory system according to claim 1, wherein the controller selects a first block based on a volume of the valid data included in the second management information, and moves valid data in the first block to a writable second block.

7. The memory system according to claim 6, wherein the controller preferentially selects as the first block a block having a smaller volume of the valid data.

8. The memory system according to claim 1, wherein the second management information includes a record of the number of reads performed in each block.

9. The memory system according to claim 1, wherein the first memory is an NAND-type flash memory.

10. A method of controlling a first memory including a plurality of blocks, each of the plurality of blocks including a plurality of pages, of the plurality of pages being a unit of data writing, the method comprising:
storing first management information and second management information in a second memory, the first management information including an information that associates a logical address specified from outside with a physical address of the first memory, the second management information including an information which has a volume of valid data in each block;
updating the first management information and the second management information in accordance with data written into the first memory;
saving a differential data and the second management information in one page of the first memory, the differential data being a difference between before and after update of the first management information; and
loading the second management information stored in the first memory into the second memory when restoring the second management information.

11. The method according to claim 10, wherein the saving further includes collecting the differential data and first data that is a part of the second management information, and recording second data in the first memory, the second data including the differential data and the first data.

12. The method according to claim 11, wherein the second data includes location information indicating a location at which the first data is stored in the second management information, the second management information being stored in the second memory.

13. The method according to claim 12, wherein the saving further includes acquiring, as the first data, third data which follows data corresponding to a part of the second management information stored in the first memory previously, the third data being a part of the second management information.

14. The method according to claim 11, further comprising recording the second management information in the first memory less frequently than the frequency of saving the differential data in the first memory, wherein
the restoring further includes loading the second management information recorded in the first memory into the second memory and then overwriting the first data included in the second data to the loaded second management information.

15. The method according to claim 10, further comprising:
selecting a first block based on a volume of the valid data included in the second management information; and
moving valid data in the first block to a writable second block.

16. The method according to claim 15, wherein the selecting includes preferentially selecting as the first block a block having a smaller volume of the valid data.

17. The method according to claim 10, wherein the second management information includes a record of the number of reads performed in each block.

18. The method according to claim 10, wherein the first memory is an NAND-type flash memory.
